(19) United States
(12) Patent Application Publication
(10) Pub. No.: US 2008/0210879 A1
(43) Pub. Date: Sep. 4, 2008

(54) Method for Controlling Leakage Rate of Active Carbon Filters

(75) Inventor: Pascal Gontier, Ste Genevieve Des Bois (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Maintenance Securite Installation Service, Gif Sur Yvette (FR)

(21) Appl. No.: 11/994,663

(22) PCT Filed: Jul. 7, 2006
(86) PCT No.: PCT/EP2006/064021

§ 371 Date: Jan. 4, 2008

(30) Foreign Application Priority Data
Jul. 11, 2005 (FR) 05 52136

(51) Int. Cl. H01J 47/00

(52) U.S. Cl. 250/379

(57) ABSTRACT

The invention concerns a method for measuring the leakage rate of an activated carbon filter, characterised in that it comprises the following steps:
injecting into the circuit comprising the filter to be tested a gas mixture comprising a carrier gas and a gas trappable by said filter to be tested,
sampling, upstream and downstream of the filter, a relative amount of said gas mixture in storage means,
measuring the amount of trappable gas contained in each of the storage means using a photoionisation chromatograph,
determining the leakage rate by comparing the relative amount of trappable gas present downstream and the relative amount of trappable gas present upstream of the filter.

### TECHNICAL FIELD

The method according to the invention enables the leakage rate of activated carbon filters to be controlled.

### STATE OF THE PRIOR ART

On nuclear sites, devices known as “hazard devices” are always equipped with one or several filters, the function of which is to capture toxic materials and thereby avoid them being expelled into the atmosphere or into an environment occupied by human personnel (for example, the maintenance teams for said devices).

These filters are generally constituted of activated carbon.

While in use, the filters must be regularly controlled. To do this, their leakage rate is checked, in other words the amount of material that should be captured and that is not captured. Several methods enabling this leakage rate to be verified exist.

For example, to measure the leakage rate of activated carbon filters, the EDF Company uses methyl iodide (containing iodine 127). The disadvantage of this product is that it is particularly toxic for humans and the environment. Indeed, methyl iodide causes irritations to the eyes and skin, nausea, vomiting, diarrhoea and visual disorders. It can cause persistent mental disorders and permanent damage to the central nervous system, leading to coma and death. Carcinogenic effects are also suspected in humans. In addition, the EDF Company uses a specific device for measuring methyl iodide that is manufactured by an American company. However, this American company has stopped producing these measuring devices and no longer assures the maintenance of existing devices. It is therefore necessary to find another method for measuring the leakage rate.

The CAMFIL Company, which manufactures activated carbon filters, uses a measurement method employing a chromatograph comprising a flame ionisation detector (FID), which continuously detects the presence of cyclohexane in the ventilation circuit upstream and downstream of the spot where the filter to be tested is located. The disadvantage of this method is that the flame ionisation detector uses dihydrogen as fuel. However, dihydrogen is explosive and cannot therefore be used in a hazard sector such as a nuclear power plant. In addition, the FID chromatograph is a heavy and bulky measuring device: it is therefore not easy to move and it cannot measure the leakage rate of filters located in distant ventilation ducts.

The aim of the invention is therefore to find a method for controlling the leakage rate of an activated carbon filter that can be used in the nuclear sector, which is reliable and less hazardous, and which can be used “in situ”.

### DISCLOSURE OF THE INVENTION

This aim is attained by a method for measuring the leakage rate of an activated carbon filter, characterised in that it comprises the following steps:
injecting into the circuit comprising the filter to be tested a gas mixture comprising a carrier gas and a gas trappable by said filter to be tested,
sampling, upstream and downstream of the filter, a relative amount of said gas mixture in storage means,
measuring the amount of trappable gas contained in each of the storage means using a photoionisation chromatograph,
determining the leakage rate by comparing the relative amount of trappable gas present downstream and the relative amount of trappable gas present upstream of the filter.

The upstream and downstream samplings of the filter correspond to a sampling at a spot located before the filter and a sampling at a spot located after the filter in the circuit.

“Measuring the amount of trappable gas contained in each of the storage means” should be taken to mean that the amount of trappable gas present in the gas mixture sampled upstream and downstream of the filter is measured.

The circuit comprising the filter to be tested may be a ventilation circuit or a safety circuit, for example in the event of leakage of a radioactive compound on a nuclear site.

Generally, the same amount of gas upstream and downstream of the filter is sampled. To obtain the determination of the leakage rate, it is therefore enough to determine the ratio (fraction) of the measurement of trappable gas downstream compared to the measurement of trappable gas upstream. To check the condition of the filter or check that it is correctly positioned, this leakage rate value obtained can be compared with a table of values, and in particular with a limit value from which it is estimated that the leakage rate is too high and that it is necessary to change the filter or to reposition it correctly.

Advantageously, to perform the injection, a specific device developed to inject the “trappable gas” product (for example cyclohexane) into the circuit containing the filter (for example a ventilation duct) in gaseous form is used. All of the product (for example around 5 mL) is injected within several seconds. The injection device is designed so as to make the injection of the product reproducible.

Advantageously, the trappable gas is a non toxic gas for humans and/or the environment.

According to a first embodiment, the trappable gas is cyclohexane.

According to a second embodiment, the trappable gas is butanone.

Advantageously, the trappable gas is a gas having a retention by activated carbon comprised between 25 and 30%.

Advantageously, the trappable gas is chosen among butyl acetate, acetic acid, acrylic acid, lactic acid, sulphuric acid, methyl acrylate, acrylonitrile, butyl alcohol, ethyl alcohol, propyl alcohol, benzene, bromium, chlorobenzene, chlorobutadiene, chloroform, chloronitropropane, chloropicrin, methylene chloride, cyclohexanol, dibromoethane, diethylketone, dioxane, petrol, ethylbenzene, tars, burnt fats, iodine, kerosene, mercaptans, monochlorobenzene, naphthalene, nitrobenzene, fragrances, perchloroethylene, phenol, ethyl silicate, styrene monomer, turpentine, tetrachloroethane, carbon tetrachloride, toluene, trichlorethylene, oil vapour, xylene.

Advantageously, the storage means are leak tight recipients or reservoirs, for example TEDLAR® type leak tight plastic bags. The use of leak tight recipients or reservoirs enables the measurements to be repeated over time (for example to recheck measurements carried out the previous day).

The method according to the invention has the advantage of enabling the “in situ” leakage rate of activated carbon filters fitted in nuclear ventilation systems to be controlled. Indeed, firstly, the method according to the invention comprises a measuring device (PID chromatograph) that does not use a flammable product like the FID chromatograph for example and, secondly, the PID chromatograph used is not very bulky and can therefore be moved easily.

With this method, the current method of controlling with methyl iodide ICH₃ tagged with iodine 127 is replaced by a more reliable and less hazardous control method.

In addition, the use of a photoionisation chromatograph (PID) enables the efficiency of filters to be evaluated from an injection using a very small amount of product (for example of cyclohexane).

### DETAILED DESCRIPTION OF SPECIFIC EMBODIMENTS

As example of application of the method according to the invention, we are going to carry out the control of the leakage rate of an activated carbon filter using a PID chromatograph. It should be noted that activated carbon filters are sometimes also known as “iodine trap” filters because such filters can also trap iodine. The activated carbon used to make the filters is prepared from bituminous coal or coconut. It is subjected to thermal or chemical activation treatments that give it a high specific surface of around 1000 to 1700 m²/g. The pores of the activated carbon have diameters of around a nanometre, in other words the same order of magnitude as molecules. The adsorption by the activated carbon of molecules in gas or vapour form diluted in air depends on several factors, and in particular the temperature, the hygrometry and the concentration of the gas or vapour.

To quantify the gas trappable by the filter present upstream and downstream of the filter in order to obtain the leakage rate of the filter, a PID chromatograph is used. The PID chromatograph comprises a photoionisation detector that ionises the eluted components conveyed by the carrier gas through a column by using a source of ultraviolet rays. Only eluted components that have an ionisation energy less than the photonic energy of the source of ultraviolet light are ionised and collected on an electrode. It is therefore important to choose a source of ultraviolet rays of suitable energy as a function of the ionisation potentials of the compounds that it is wished to analyse. In the example below, cyclohexane is going to be introduced into the carrier gas; the UV lamp is therefore chosen with an energy of 10.6 eV. The current variation that results from the ionisation of components is measured with an electrometer and depends on the concentration of the eluted components contained in the carrier gas and, consequently, depends on the amount of trappable gas contained in the carrier gas.

The sample to be detected (here the gas trappable by the filter) is introduced into the chromatograph in gaseous form and is transported by a carrier gas that enables the components of the sample to be eluted in the chromatography column of the chromatograph. It should be recalled that a chromatograph comprises the following principal elements: a chromatography column, an injection device, in other words a means by which the sample is introduced into the chromatography column in gas phase, a detector and a data processing system. The carrier gas must be sufficiently pure and inert to the sample so as not to falsify the measurements of the sample. The carrier gases the most often used are hydrogen, helium-methane mixture, nitrogen, argon-methane mixture and air. The choice of carrier gas depends on the conditions of use. In our example, since it is wished to calculate the leakage rate of an activated carbon filter generally used in ventilation ducts, reconstituted air is chosen to be used as carrier gas, in order to be as close as possible to sampling conditions under real conditions.

In practice, the method according to the invention enables the control of the activated carbon filter to be carried out directly on the ventilation circuit in which it is located (“in situ” measurement). In our application example, we carry out the measurements by placing the activated carbon filter in a test bench. In other words, to control the leakage rate of the filter, a test bench is formed, which is going to simulate a circuit or a ventilation duct comprising an activated carbon filter to be tested. The test bench comprises a Very High Efficiency (VHE) filter, an activated carbon filter and a High Efficiency (HE) filter. The VHE filter assures the protection of the activated carbon filter to dust, whereas the High Efficiency (HE) filter, installed at the input of the ventilation circuit, assures the absence of intrusion of dust or residues from the exterior into the ventilation duct. The test bench is equipped with a small diameter by-pass that bypass the activated carbon filter. This by-pass enables leakages on the activated carbon filter or “iodine trap” to be simulated by placing diaphragms of known diameter in the by-pass. The test bench further comprises a ventilator, which circulates the gas contained in the test bench, a regulator enabling the flow rate of gas in the test bench to be adjusted and connections enabling the gas to be injected and/or sampled in the test bench. The calculation of the leakage rate of the filter will make it possible to determine, for example, if the filter is correctly positioned (correct assembly of the filter) and that it has not undergone deterioration during handling.

To carry out tests intended to control the leakage rate of the activated carbon filter, a generator of cyclohexane in gaseous form, combined with an upstream and downstream sampling system of the activated carbon filter to be controlled is used. In our example, the generator sucks up cyclohexane in liquid form inside an oven heated to a temperature of 200° C.; the cyclohexane is then vaporised and injected into the test bench. At the same time, a sampling by suction is carried out upstream and downstream of the activated carbon filter of the same amount of air into TEDLAR® type sample bags. For example, the injection time may be 30 seconds and the sampling time 1 minute. The injection time and the sampling time may be adjusted as a function of the requirements, the flow rate of the ventilation circuit to be tested or the capacity of the TEDLAR® bag used.

During our tests, we used an activated carbon filter of the CAMFIL Company of dimensions 610×610×292 having a volume of activated carbon of 65 dm³, a useful surface area of the bed of activated carbon of 130 dm³ and a maximum flow rate of 1200 m³/h (data provided by CAMFIL).

In our test bench, a determined amount of a gas trappable by the filter is therefore injected, in gaseous form, for a fixed flow rate of the control bench. For example, 5 ml of cyclohexane is injected into the test bench upstream of the filter to be controlled for a flow rate of the test bench set at 1200 m³/h. We have to work at flow rates comprised between 750 m³/h and 50000 m³/h (1200 m³/h is the maximum flow rate for an activated carbon filter; but in a ventilation circuit, there may be several filters arranged in parallel; the flow rate is then multiplied by the number of filters). It is therefore possible to choose to inject a different amount of gas according to the chosen flow rate (which will depend on the characteristics of the filter) or depending on the nature of the gas chosen.

In our example, cyclohexane (C₆H₁₂) has been chosen, since in gaseous form it is perfectly retained by the activated carbon filter. However, any other gaseous product that has the same characteristics as cyclohexane and which is retained in the same way by the activated carbon filter can also be chosen. The choice of the gas will be made for example as a function of the requirements of the user, the availability of the product or the toxicity of the product for the user or for his or her environment.

A list of gaseous products capable of being used instead of cyclohexane is given below. These products are indeed strongly retained by activated carbon filters (retention of around 25 to 30%).

List of products in gaseous form trappable by activated carbon filters:

Butyl acetate, acetic acid, acrylic acid, lactic acid, sulphuric acid, methyl acrylate, acrylonitrile, butyl alcohol, ethyl alcohol, propyl alcohol, benzene, bromium, chlorobenzene, chlorobutadiene, chloroform, chloronitropropane, chloropicrin, methylene chloride, cyclohexane, cyclohexanol, dibromoethane, diethylketone, dioxane, petrol, ethylbenzene, tars, burnt fats, iodine, kerosene, mercaptans, monochlorobenzene, naphthalene, nitrobenzene, fragrances, perchloroethylene, phenol, ethyl silicate, styrene monomer, turpentine, tetrachloroethane, carbon tetrachloride, toluene, trichlorethylene, oil vapour, xylene.

Preferably, the gaseous product is chosen to be the least toxic possible and detectable using the PID chromatograph. A gas that is non toxic and trappable by activated carbon is chosen. Cyclohexane is a good choice, but butanone, ethyl acetate, cyclohexene, etc. may also be used.

To carry out the injection of the gas, an oven is filled with 5 ml cyclohexane in liquid form; once this operation has been carried out, the oven is heated and the cyclohexane evaporates. The gas thereby formed is propelled with compressed air into the control bench.

At the same time as the injection of the gas into the test bench, a sampling of the gas is carried out upstream and downstream of the activated carbon filter. In practice, it is preferred that the injection of the cyclohexane in gaseous form automatically triggers the samplings in the UPSTREAM and DOWNSTREAM bags. In the same way, the stopping of the sampling is automatic, for example when the upstream and downstream TEDLAR® bags are full.

In order to recover a sufficient and representative amount of gas, a pump for which the sampling flow rate is known is used. For example, it is possible to use a sampling pump having a sampling flow rate of around 30 litres a minute, which is going to sample a part of the gas contained in the control bench upstream and downstream of the filter and transfer it, firstly, into the storage means located upstream and, secondly, into the storage means located downstream of the filter, respectively. Preferably, one waits until the upstream and downstream sampling flow rates are stabilised before carrying out the sampling. The regulation of the flow rates may be assured by mass flow meters.

The storage means are for example TEDLAR® bags with a capacity of 50 L. These TEDLAR® bags are robust, not bulky (when unfilled) and easy to use. Since the flow rate of the sampling pump is 30 litres a minute, the TEDLAR® bags are filled in a little over one minute.

Then the analysis of cyclohexane is carried out. As has been pointed out previously, the analysis of the cyclohexane is carried out using a photoionisation chromatograph or PID. To do this, the TEDLAR® bag corresponding to the upstream sampling is connected to the PID chromatograph and its concentration is calculated. Then, the same procedure is followed for the TEDLAR® bag corresponding to the downstream sampling. A part of the gas contained in the TEDLAR® bag (upstream or downstream) is injected, by injection loop of a half centimetre cube, directly into a pre-column acting as an injector. The gas is then injected into an analysis column of the chromatograph. The analysis column has a polyethylene glycol packing suitable for the analysis of alcohols, ketones and aldehydes and, in particular, cyclohexane.

At the outlet of the column, the gas reaches the PID detector, composed of an electrode sensor and an ultraviolet lamp that provides light radiation of 10.6 eV and ionises the gas. The current variation that results from the ionisation of the gas is measured and integrated, then reconstructed in the form of a graph giving the intensity as a function of time. The peak stemming from the electron emission is proportional to the number of excited molecules. A precise value of the concentration in the carrier gas is then obtained.

The results obtained by the chromatograph are in the form of graphs in which the presence of cyclohexane is signalled by a peak; the calculation of the peak area provides the concentration in ppm of cyclohexane.

The “peak area upstream” over “peak area downstream” ratio of the cyclohexane enables the leakage rate of the filter to be determined. This leakage rate is then compared to a limit value to determine if the filter is damaged and/or incorrectly positioned in the circuit, here a ventilation circuit.

We carried out several tests on this test bench. For all the tests carried out, the test bench has a flow rate of 1200 m³/h. 5 mL of cyclohexane is injected into the test bench and the injection time is 30 seconds. The upstream (or downstream) sampling is carried out using a pump having a flow rate of 30 L a minute and the sampling lasts 1 minute.

The first test is a test carried out with the by-pass closed to check that the same amount of cyclohexane at the UPSTREAM and DOWNSTREAM sampling points is indeed obtained when there is no activated carbon filter placed in the test bench.

| | Amount | Amount |
|---|---|---|
| | upstream | downstream |
| | (ppm) | (ppm) |
| Measurement carried out | 19.75 | 18.71 |
| just after sampling | | |
| Measurement carried out 15 | 19.32 | 18.67 |
| minutes after sampling | | |
| Measurement carried out | 19.04 | 18.09 |
| the next day | | |

By comparing the results, it is seen that the upstream and downstream samplings of the activated carbon filter are representative.

The second test is carried out with the by-pass closed, but by placing the activated carbon filter in the test bench.

The following results are obtained:

| | Amount | Amount |
|---|---|---|
| | upstream | downstream |
| | (ppm) | (ppm) |
| Measurement carried out | 36.65 | 9.79 · 10⁻³ |
| just after sampling | | |

The leakage rate of the activated carbon filter tested is 2.67.10⁻⁴ (9.79.10⁻³ ppm/36.35 ppm).

The efficiency of the filter is 3744 (36.65 ppm/9.79.10⁻³ ppm).

With these leakage rate and efficiency values, it may be considered that the filter is correctly placed in the test bench and that it is not damaged.

Depending on the application, the efficiency criteria vary. The minimum efficiency below which the activated carbon filter needs to be replaced varies from 300 to 1000.

The third test is carried out by placing the activated carbon filter in the test bench and by fully opening the by-pass (no diaphragm is placed in the by-pass).

The following results are obtained:

| | Amount | Amount |
|---|---|---|
| | upstream | downstream |
| | (ppm) | (ppm) |
| Measurement carried out | 26.49 | 148 · 10⁻³ |
| just after sampling | | |

The leakage rate of the activated carbon filter tested is 5.59.10⁻³ (148.10⁻³ ppm/26.49 ppm).

The efficiency of the filter is 179 (26.49 ppm/148.10⁻³ ppm)

With these leakage rate and efficiency values, it may be considered that the activated carbon filter is not efficient. There is considerable leakage.

The fourth test is carried out by placing the activated carbon filter in the test bench and by placing a 2 mm diaphragm in the by-pass.

The following results are obtained:

| | Amount | Amount |
|---|---|---|
| | upstream | downstream |
| | (ppm) | (ppm) |
| Measurement carried out | 26.44 | 76.14 · 10⁻³ |
| just after sampling | | |

The leakage rate of the activated carbon filter tested is 2.77.10⁻³ (76.14.10⁻³ ppm/27.44 ppm).

The efficiency of the filter is 360 (27.44 ppm/76.14.10⁻³ ppm).

With these leakage rate and efficiency values, it may be considered that the filter is more efficient than previously; it can be seen that our method enables the leakage rate to be evaluated depending on the diameter of the leakage.

Finally, the fifth test is carried out by placing the activated carbon filter in the test bench and by placing a 0.3 mm diaphragm in the by-pass.

The following results are obtained:

| | Amount | Amount |
|---|---|---|
| | upstream | downstream |
| | (ppm) | (ppm) |
| Measurement carried out | 33.34 | 15.16 · 10⁻³ |
| just after sampling | | |

The leakage rate of the activated carbon filter tested is 4.54.10⁻⁴ (15.16.10⁻³ ppm/33.34 ppm).

The efficiency of the filter is 2199 (33.34 ppm/15.16.10⁻³ ppm).

With these leakage rate and efficiency values, it may be considered that the filter is efficient.

In conclusion, it may be considered that our method according to the invention is efficient to evaluate very low leakage rates.

The method according to the invention is advantageous since it enables the leakage rate of activated carbon filters to be controlled in a reliable manner without having the constraints of using a toxic product. Since samples are taken in the storage means and since said storage means are then moved to the PID chromatograph type measuring device, it is possible to carry out measurements on different systems on a same site with a single and same measuring device. In particular, the additional advantage of the use of the PID chromatograph is that in addition to being able to be used in a hazard environment, for example on a site comprising a nuclear reactor, it moreover has a very wide sensitivity extending from ppm (parts per millions) to ppb (parts per billion).

At present, the efficiency of activated carbon filters is measured using a normalised method (NFM 62-206 standard) that uses methyl iodide (CH₃I) tagged with radioactive iodine 131. This product is very toxic and radioactive. It is therefore possible to envisage using the method according to the invention to carry out a leak tightness test on an activated carbon filter or iodine trap before carrying out the normalised efficiency test (NFM 62-206 standard). The preliminary test of measuring the leakage rate according to the invention, for example by using cyclohexane, thereby guarantees a low risk of discharge of radioactive iodine 131 into the atmosphere in the case where the activated carbon filter is defective.

1. A method for measuring the leakage rate of an activated carbon filter, comprising the following steps:
injecting into the circuit comprising the filter to be tested a gas mixture comprising a carrier gas and a gas trappable by said filter to be tested,
sampling, upstream and downstream of said filter, a relative amount of said gas mixture in storage means,
measuring the amount of trappable gas contained in each of said storage means using a photoionisation chromatograph, and
determining the leakage rate by comparing the relative amount of trappable gas present downstream and the relative amount of trappable gas present upstream of said filter.

2. The method according to claim 1, characterised in that the trappable gas is a non toxic gas for humans and/or the environment.

3. The method according to claim 1, characterised in that the trappable gas is cyclohexane.

4. The method according to claim 1, characterised in that the trappable gas is butanone.

5. The method according to claim 1, wherein the trappable gas is a gas having a retention by the activated carbon of between 25 and 30%.

6. The method according to claim 5, wherein the trappable gas is chosen from among butyl acetate, acetic acid, acrylic acid, lactic acid, sulphuric acid, methyl acrylate, acrylonitrile, butyl alcohol, ethyl alcohol, propyl alcohol, benzene, bromium, chlorobenzene, chlorobutadiene, chloroform, chloronitropropane, chloropicrin, methylene chloride, cyclohexanol, dibromoethane, diethylketone, dioxane, petrol, ethylbenzene, tars, burnt fats, iodine, kerosene, mercaptans, monochlorobenzene, naphthalene, nitrobenzene, fragrances, perchloroethylene, phenol, ethyl silicate, styrene monomer, turpentine, tetrachloroethane, carbon tetrachloride, toluene, trichlorethylene, oil vapour, and xylene.

7. The method according to claim 1, characterised in that the storage means are leak tight plastic bags.
